(19) United States
(12) Patent Application Publication
(10) Pub. No.: US 2012/0058821 A1
(43) Pub. Date: Mar. 8, 2012

(54) PROJECTING HANDHELD GAME CONSOLE AND OPERATING METHOD THEREOF

(75) Inventor: SHUN-CHIEN LAN, Tu Cheng (TW)

(73) Assignee: Cheng Uei Precision Industry Co., LTD., Tu Cheng City (TW)

(21) Appl. No.: 12/876,112

(22) Filed: Sep. 4, 2010

(51) Int. Cl. A63F 13/06; A63F 13/00

(52) U.S. Cl. 463/30; 463/37

(57) ABSTRACT

Disclosed is a projecting handheld game console and operating method thereof. The projecting handheld game console comprises a main body and a game handle to control the main body. The main body comprises a basic part and a projecting part which is fold connected to the basic part. The surface of the basic part has a display screen to display game images, and the projecting part has a projecting module to project and enlarge the game images. The projecting handheld game console can always adjust the height of the projector of the picture and overcome the shaking of the current handheld game consoles, then really satisfy a majority of gamers to see large screen gaming effects and to play together.

### BACKGROUND OF THE INVENTION

1. Field of the Invention

The present invention generally relates to a projecting handheld game console and operating method thereof.

2. Description of Prior Art

With rapid development of handheld game console industry, kinds of handheld game console with LCD are constantly brought to the consumer market and become popular for numerous gamers. However, the LCDs equipped on the handheld game consoles are small. Therefore, the gamers cannot enjoy the large screen gaming effects and without astonishing visual effects as playing. For experiencing the astonish large screen gaming visual effects, it is necessary to connect the handheld game console with a larger display screen of a NB or a LCD TV for seeing the large screen gaming visual effects. However, it is so inconvenient and unpractical for satisfying the basic requirements of the numerous gamers to play games in communication or in travel anywhere, anytime but still able to enjoy astonish large screen gaming effects.

Recently, as much popular as a micro projector can be, a lot of mobile phones and cameras are also loaded with such additional project function. Similarly, the project function also walks into the world of the handheld game consoles. However, the current projecting handheld game consoles generally combine the display screen, the main body, the game handle and the projecting module in one unit. Therefore, drawbacks consequently come with the aforesaid design: First, the height and the size of the projector of the picture cannot be adjusted when playing game because both the projecting module and the display screen are set in the same unit. Second, the control (operation) of the game handle always results in the shaking of the current handheld game consoles and leads to an unstable projector of the gaming picture. As a result, an unclear and loomed gaming picture shows up and makes eyes of the gamers uncomfortable. Beside, the current projecting handheld game consoles are designed for one gamer only and cannot allow a majority of gamers to play together. \

Consequently, there is a need to provide a projecting handheld game console to overcome the shaking of the current handheld game consoles and really satisfy a majority of gamers to see large screen gaming effects and to play together.

### SUMMARY OF THE INVENTION

For solving the drawbacks of aforementioned prior art, an objective of the present invention is to provide a projecting handheld game console capable of adjusting the height of the projector of the picture and overcoming the shaking of the current handheld game consoles, then really satisfying a majority of gamers to see large screen gaming effects and to play together.

Another objective of the present invention is to provide an operation method of the projecting handheld game console to adjust the height of the projector of the picture and overcome the shaking of the current handheld game consoles.

For realizing the aforesaid objective, the projecting handheld game console of the present invention comprises a main body and a game handle to control the main body. The main body comprises a basic part and a projecting part which is fold connected to the basic part. The surface of the basic part has a display screen to display game images. The projecting part has a projecting module to project and enlarge the game images. The game handle can be separated from the main body and couples with the main body with wireless communication.

For realizing the aforesaid objective, the present invention provides an operating method of the projecting handheld game console, comprising steps of: first, activating the projecting module of the main body; then, detecting whether the game handle is separated from the main body when the main body receives a request of projecting; and projecting the game images as the game handle is detected in a status of separation with the main body.

As aforementioned, the projecting handheld game console of the present invention not merely combines the project function with the handheld game console. Moreover, the projecting handheld game console of the present invention can always adjust the height of the projector of the picture and overcome the shaking of the current handheld game consoles, then really satisfy a majority of gamers to see large screen gaming effects and to play together.

### BRIEF DESCRIPTION OF THE DRAWINGS

FIG. 1 shows a three dimensional view diagram of a first embodiment of a projecting handheld game console according to the present invention.

FIG. 2 shows a three dimensional view diagram of the projecting handheld game console shown in FIG. 1 from another angle.

FIG. 3 shows a three dimensional view diagram of the main body and the game handle of the projecting handheld game console in a status of separation.

FIG. 4 shows a three dimensional view diagram of the main body shown in FIG. 3 from another angle.

FIG. 5 shows a three dimensional view diagram of the game handle shown in FIG. 3.

FIG. 6 shows a control block diagram of the projecting handheld game console according to the present invention.

FIG. 7 shows a flow chart of an operation method of the projecting handheld game console according to the present invention.

### DETAILED DESCRIPTION OF THE INVENTION

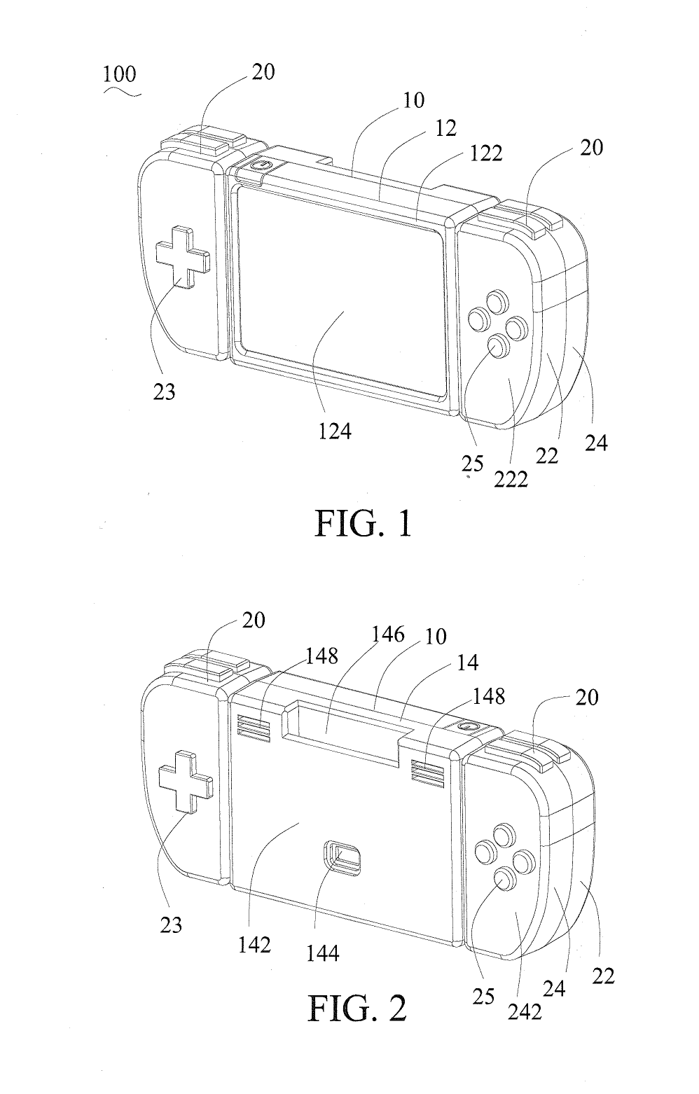

Please refer to FIG. 1 and FIG. 2. The projecting handheld game console 100 of the present invention comprises a main body 10 and a game handle 20 to control the main body 10. In this embodiment, the game handle 20 of the projecting handheld game console 100 has two parts, respectively positioned at both sides of the main body 10 and removably plugged and connected to the main body 10. As the game handle 20 is separated from the main body 10, the game handle 20 can remains to be electrically connected with the main body 10 for controlling the main body 10.

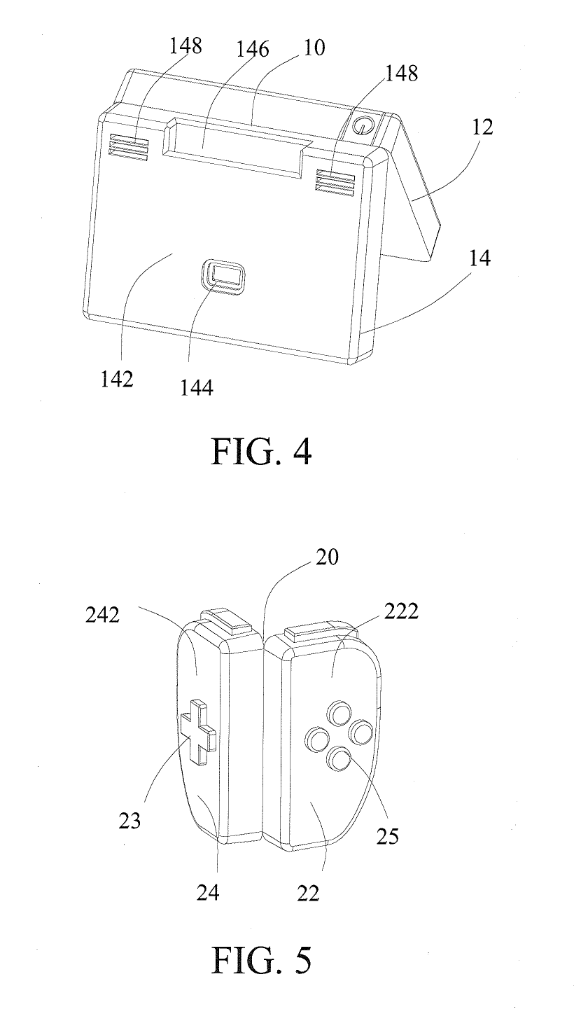

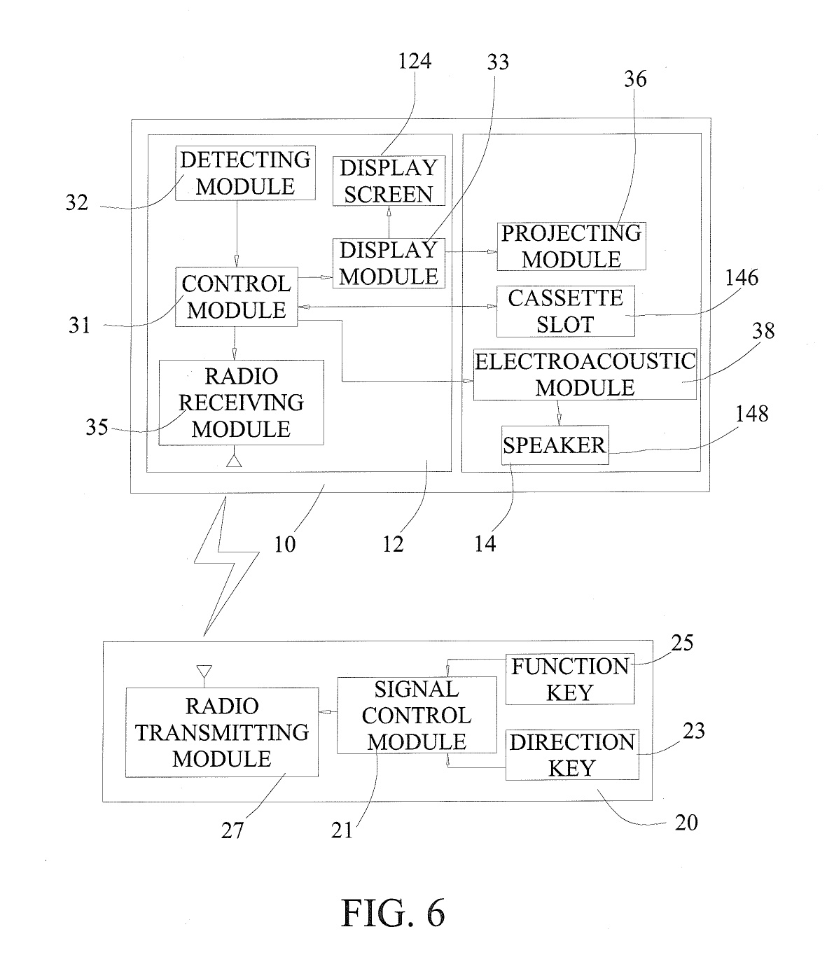

Please refer to FIG. 1, FIG. 2 and FIG. 4. The main body 10 comprises a basic part 12 and a projecting part 14, fold connected to the basic part 12. The surface of the basic part 12 is setup with a display screen 124 for displaying game images. Preferably, the display screen 124 can be a touch-control LCD. The projecting part 14 comprises a projecting module 36 for projecting and enlarging the game images (as shown in FIG. 6). A projecting hole 144 is located exactly to the lens (not shown) of the projecting module on the projecting part surface 142 of the projecting part 14 for projecting out the game images.

The projecting part 14 of the main body 10 further comprises a cassette slot 146 and two speakers 148 positioned at both sides of the cassette slot 146. The cassette slot 146 is used for inserting a memory cassette storing many kinds of games. The speakers 148 are used for game sounds. The basic part 12 and the projecting part 14 are fold connected and an unfold angle therebetween is adjustable. Therefore, an angle and a height of the projecting hole 144 can be adjusted for adjusting the height and the size of the projector of the picture (the game images) on the display screen 124 to obtain a best view angle and a project effect.

Please refer to FIG. 1, FIG. 2 and FIG. 5. The game handle 20 comprises a front cover 22 and a rear cover 24, fold connected with each other. A direction key 23 or a function key 25 is positioned on an outer surface 222 of the front cover 22. A function key 25 or a direction key 23 is positioned on an outer surface 242 of the rear cover 24. In this embodiment, the game handle 20 has two parts, respectively positioned at both sides of the main body 10 and electrically connected with the main body 10 for controlling the main body 10. Moreover, game handle 20 is removably plugged and connected to the main body 10. As the game handle 20 is separated from the main body 10, the game handle 20 can wirelessly control the main body 10 conveniently. When the game handle 20 is connected with the main body 10, the gamer can run a single game with the game handle 20 connected with the main body 10 according to his habit. The gamer can do settings on the projecting handheld game console 100 to make respective part of the game handle 20 with only one key enable. For example, the gamer can make the left part of the game handle 20 with direction key 23 enable and make the right part of the game handle 20 with function key 25 enable and vice versus. Alternatively, the game handle 20 can be designed for one part left according to the present invention. Then, the direction key 23/the function key 25 on the front cover 22 and the function key 25/the direction key 23 on the rear cover 24 are enabled at the same time to allow the gamer to play game with one hand only.

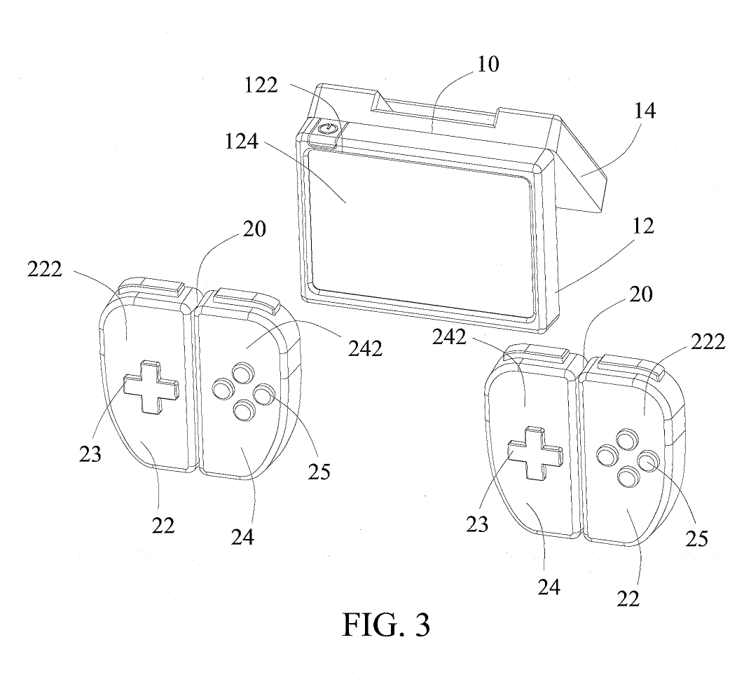

Please refer to FIG. 3, which shows a three dimensional view diagram of the main body and the game handle of the projecting handheld game console in a status of separation. Both the two parts of the game handle 20 are separated from the main body 10 and unfold to become two independent game handles. The two independent game handles can wirelessly control the main body 10 with transceiving radio signals to allow two gamer to play the game. Because the game handle 20 can wirelessly control the main body 10 in the status of separation as shown in FIG. 3, the basic part 12 and the projecting part 14 of the main body 10 can be unfold to stand on a flat. Meanwhile, an unfold angle between the basic part 12 and the projecting part 14 is adjustable to adjust the angle and the height of the projecting hole 144 for adjusting the height and the size of the projector of the picture (the game images) on the display screen 124 to obtain a best view angle and a project effect. Obviously, the game handle 20 can be separated from the main body 10, therefore, the shaking of the projecting handheld game console 10 and the unstable projector of the gaming picture caused by the control of the game handle 20 can be efficiently prevented. The projecting handheld game console 100 of the present invention can really satisfy a majority of gamers to see large screen gaming effects. Besides, the front cover 22 and the rear cover 24 of the game handle 20 can be unfold with a certain degree (generally with 180°) for control according to their habits.

Please refer to FIG. 6, which shows a control block diagram of the projecting handheld game console 100 according to the present invention. The basic part 12 of the main body 10 comprises a control module 31, a detecting module 32 and a radio receiving module 35 coupled with the control module 31 and a display module 33 coupled with the control module 31 and controlling the display screen 124. The detecting module 32 is used for detecting whether the game handle 20 is separated from the main body 10 (in the status of separation). The projecting part 14 of the projecting part 14 comprises a projecting module 36 coupled with the display module 33, a cassette slot 146 coupled with the control module 31 and an electroacoustic module 38 coupled with the speakers 148 for controlling thereof. The game handle 20 comprises a signal control module 21, a radio transmitting module 27 coupled with the signal control module 21, the function key 25 and the direction key 23. According to the operations to the direction key 23 and the function key 25, the operation control signals are transformed into radio signals to be transmitted to the radio receiving module 35 of the main body 10. Accordingly, the gamer can wirelessly control the main body 10 and play the games.

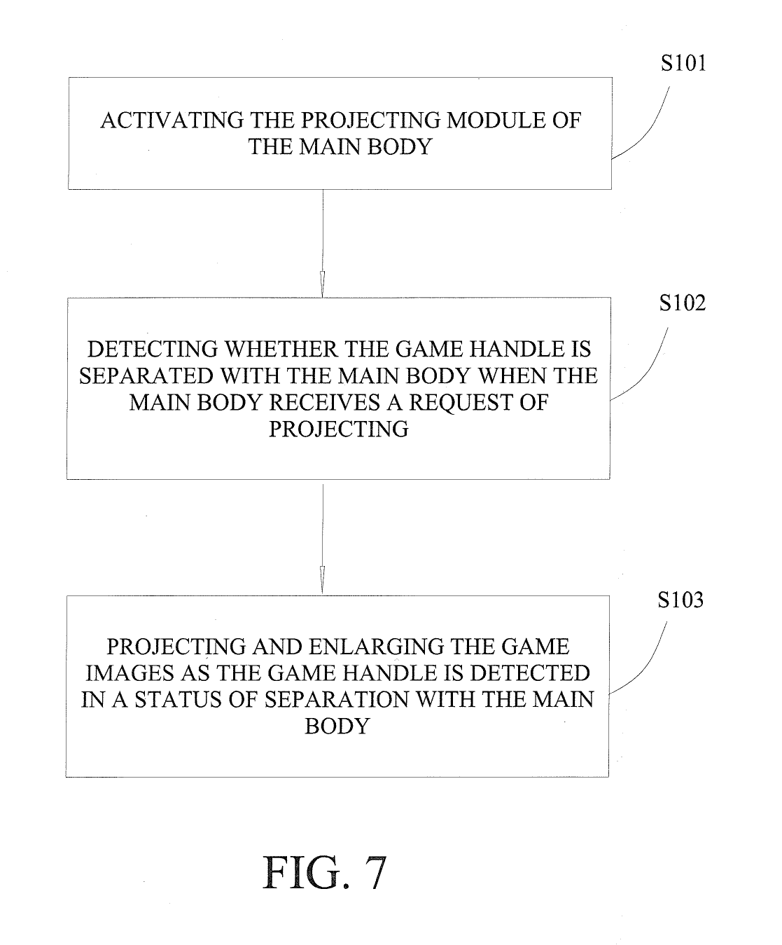

Please refer to FIG. 7, which shows a flow chart of an operation method of the projecting handheld game console according to the present invention. The operation method comprises steps of:

S101: activating the projecting module of the main body;
S102: detecting whether the game handle and the main body are in a status of separation when the main body receives a request of projecting; and
S103: projecting the game images as the game handle is detected in a status of separation with the main body.

Preferably, two main bodies 10 of the two projecting handheld game console 100 can be stand side by side to project the game images in a way of extending projectors of the pictures. Ultimately, four gamers can play the game at the same time.

As aforementioned, the projecting handheld game console of the present invention not merely combines the project function with the handheld game console. Moreover, the projecting handheld game console of the present invention can always adjust the height of the projector of the picture and overcome the shaking of the current handheld game consoles, then really satisfy a majority of gamers to see large screen gaming effects and to play together.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A projecting handheld game console, comprising:
a main body; and
a game handle, used for controlling the main body;
wherein the main body comprises:
a basic part, having a display screen positioned on a surface thereof to display game images; and
a projecting part, being fold connected to the basic part and having a projecting module to project and enlarge the game images.

2. The projecting handheld game console of claim 1, wherein the main body further comprises a control module, a detecting module and a radio receiving module coupled with the control module and a display module coupled with the control module and controlling the display screen, wherein the projecting module is coupled with the display module.

3. The projecting handheld game console of claim 1, wherein the game handle is removably connected to the main body.

4. The projecting handheld game console of claim 2, wherein the game handle comprises a radio transmitting module in accordance with the radio receiving module of the main body, a signal control module coupled with the radio transmitting module, wherein a function key and a direction key positioned on the game handle are used for inputting control signals into the signal control module.

5. The projecting handheld game console of claim 4, wherein the game handle a front cover and a rear cover fold connected with each other, wherein one of the function key and the direction key is positioned on the front cover and the other is positioned on the rear cover.

6. The projecting handheld game console of claim 1, wherein the projecting part of the main body further comprises a cassette slot and speakers positioned at both sides of the cassette slot.

7. An operating method of the projecting handheld game console of claim 2, comprising steps of:
activating the projecting module of the main body;
detecting whether the game handle is separated from the main body when the main body receives a request of projecting; and
projecting the game images as the game handle is detected in a status of separation with the main body.
